(19) United States
(12) Patent Application Publication
(10) Pub. No.: US 2024/0310935 A1
(43) Pub. Date: Sep. 19, 2024

(54) MOUSE STRUCTURE

(71) Applicant: Chicony Electronics Co., Ltd., New Taipei City (TW)

(72) Inventor: Yen-Ching LEE, New Taipei City (TW)

(21) Appl. No.: 18/447,286

(22) Filed: Aug. 9, 2023

(30) Foreign Application Priority Data
Mar. 15, 2023 (TW) 112109639

(51) Int. Cl. G06F 3/0362

(52) U.S. Cl. CPC G06F 3/0362; G06F 3/03543

(57) ABSTRACT

A mouse structure includes a casing, a shaft, a supporting piece, a roller, an optical sensor and an analyzing unit. The supporting piece is connected between the casing and the shaft. The supporting piece is configured to support the shaft and allow the shaft to move relative to the casing. The shaft penetrates through and connects with the roller. The roller at least partially protrudes outside the casing and has some superficial features. The optical sensor is disposed on the casing and defines a region to be detected on the roller. The superficial features are at least partially located at the region to be detected. The optical sensor is configured to obtain some images of the region to be detected. The analyzing unit is signally connected with the optical sensor and is configured to determine a moving pattern of the roller according to the images.

### RELATED APPLICATIONS

This application claims priority to Taiwanese Application Serial Number 112109639 filed Mar. 15, 2023, which is herein incorporated by reference.

### BACKGROUND

### Technical Field

The present disclosure relates to mouse structures.

### Description of Related Art

With respect to the rapid development of science and technology, the application of computer has become an indispensable part of our lives. Apart from daily applications in general, computer applications are becoming more and more diversified in the aspects of business, academy and even entertainment.

As everyone knows, the mouse is a common operating tool in computer applications. At present, a mouse in the industry often has five basic functions, including: scrolling forwards with a sense of paragraph, scrolling backwards with a sense of paragraph, pressing down, tilting left and tilting right. Moreover, an advanced mouse in the market can even switch to a shuttle mode, which allows the roller of the mouse to rotate quickly and precisely.

In order to realize the functions above, multiple switches, encoders and complicated circuit connections are generally required to be equipped on a mouse, which will inevitably lead to problems of increment of manufacturing cost and complication in assembly. Therefore, the industry has been working to improve this situation.

### SUMMARY

A technical aspect of the present disclosure is to provide a mouse structure, which can effectively simplify the internal structure and the design of relevant electric circuit inside the mouse structure. The mouse structure can also effectively reduce the use of manufacturing materials and thus the cost involved.

According to an embodiment of the present disclosure, a mouse structure includes a casing, a shaft, a supporting piece, a roller, an optical sensor and an analyzing unit. The supporting piece is connected between the casing and the shaft. The supporting piece is configured to support the shaft and allow the shaft to move relative to the casing. The shaft penetrates through and connects with the roller. The roller at least partially protrudes outside the casing and has a plurality of superficial features. The optical sensor is disposed on the casing and defines a region to be detected on the roller. The superficial features are at least partially located at the region to be detected. The optical sensor is configured to obtain a plurality of images of the region to be detected. The analyzing unit is signally connected with the optical sensor and is configured to determine a moving pattern of the roller according to the images.

In one or more embodiments of the present disclosure, the roller has a first surface and two second surfaces. The two second surfaces are opposite to each other. The first surface is connected between the two second surfaces. The shaft penetrates through the two second surfaces. The superficial features are located on the first surface. The optical sensor perpendicularly faces to the first surface.

In one or more embodiments of the present disclosure, the optical sensor includes a light source. The light source is configured to emit a light to the region to be detected.

In one or more embodiments of the present disclosure, the roller has a first surface and two second surfaces. The two second surfaces are opposite to each other. The first surface is connected between the two second surfaces. The shaft penetrates through the two second surfaces. The superficial features are located on one of the two second surfaces. The optical sensor perpendicularly faces to a corresponding one of the two second surfaces disposed with the superficial features thereon.

In one or more embodiments of the present disclosure, at least one of the superficial features is a mark.

In one or more embodiments of the present disclosure, at least one of the superficial features is a groove.

In one or more embodiments of the present disclosure, the supporting piece allows the roller to elastically tilt relative to the casing.

In one or more embodiments of the present disclosure, the supporting piece allows the roller to elastically move towards the optical sensor.

According to an embodiment of the present disclosure, a mouse structure includes a casing, a shaft, a supporting piece, a first roller, a second roller, an optical sensor and an analyzing unit. The supporting piece is connected between the casing and the shaft. The supporting piece is configured to support the shaft and allow the shaft to move relative to the casing. The shaft penetrates through and connects with the first roller. The first roller at least partially protrudes outside the casing. The shaft penetrates through and connects with the second roller. The second roller is located inside the casing and is separated from the first roller. The second roller has a plurality of superficial features. The optical sensor is disposed on the casing and defines a region to be detected on the second roller. The superficial features are at least partially located at the region to be detected. The optical sensor is configured to obtain a plurality of images of the region to be detected. The analyzing unit is signally connected with the optical sensor and is configured to determine a moving pattern of the first roller according to the images.

In one or more embodiments of the present disclosure, the second roller has a first surface and two second surfaces. The two second surfaces are opposite to each other. The first surface is connected between the two second surfaces. The shaft penetrates through the two second surfaces. The superficial features are located on the first surface. The optical sensor perpendicularly faces to the first surface.

In one or more embodiments of the present disclosure, the optical sensor includes a light source. The light source is configured to emit a light to the region to be detected.

In one or more embodiments of the present disclosure, the first roller has a first surface and two second surfaces. The two second surfaces are opposite to each other. The first surface is connected between the two second surfaces. The shaft penetrates through the two second surfaces. The superficial features are located on one of the two second surfaces. The optical sensor perpendicularly faces to a corresponding one of the two second surfaces disposed with the superficial features thereon.

In one or more embodiments of the present disclosure, at least one of the superficial features is a mark.

In one or more embodiments of the present disclosure, at least one of the superficial features is a groove.

In one or more embodiments of the present disclosure, the supporting piece allows the first roller to elastically tilt relative to the casing.

In one or more embodiments of the present disclosure, the supporting piece allows the first roller to elastically move towards the optical sensor.

The above-mentioned embodiments of the present disclosure have at least the following advantages:

(1) Since the analyzing unit can determine through algorithm whether the first roller is rotated, tilted left, tilted right or pressed downwards, and also determine a rotating speed of the first roller, according to the images of the region to be detected on the first roller or the second roller obtained by the optical sensor, the internal structure of the mouse structure can be effectively simplified. Moreover, the design of electric circuit involved can also be simplified.

(2) Since the mouse structure can omit switches and encoders used in traditional mice, manufacturing materials and cost of manufacture can be further reduced.

### BRIEF DESCRIPTION OF THE DRAWINGS

The disclosure can be more fully understood by reading the following detailed description of the embodiments, with reference made to the accompanying drawings as follows:

FIG. 1 is a partially sectional view of a mouse structure according to an embodiment of the present disclosure;

FIG. 2 is a front view along the sectional line A-A of FIG. 1;

FIGS. 3A-3D are schematic views showing changes of the images of the region to be detected on the first roller of FIG. 1, in which the superficial features move towards the first direction;

FIGS. 4A-4D are schematic views showing changes of the images of the region to be detected on the first roller of FIG. 1, in which the superficial features move towards the second direction;

FIG. 5 is a partially sectional view of the mouse structure of FIG. 1, in which the first roller tilts towards the right side of the figure relative to the casing;

FIGS. 6A-6D are schematic views showing changes of the images of the region to be detected on the first roller of FIG. 5, in which the superficial features move towards the left side of the figure;

FIG. 7 is a partially sectional view of the mouse structure of FIG. 1, in which the first roller tilts towards the left side of the figure relative to the casing;

FIGS. 8A-8D are schematic views showing changes of the images of the region to be detected on the first roller of FIG. 7, in which the superficial features move towards the right side of the figure;

FIG. 9 is a regionally enlarged view of the first roller of FIG. 1, in which the superficial features are in blocky shapes;

FIG. 10 is a regionally enlarged view of the first roller of FIG. 1, in which the superficial features are grooves;

FIG. 11 is a partially sectional view of a mouse structure according to another embodiment of the present disclosure, in which the optical sensor perpendicularly faces to one of the two second surfaces;

FIG. 12 is a front view along the sectional line B-B of FIG. 11;

FIGS. 13A-13D are schematic views showing changes of the images of the region to be detected on the first roller of FIG. 12, in which the superficial features move towards the first direction;

FIGS. 14A-14D are schematic views showing changes of the images of the region to be detected on the first roller of FIG. 12, in which the superficial features move towards the second direction;

FIGS. 15A-15G are schematic views showing changes of the images of the region to be detected on the first roller of FIG. 12, in which the superficial features move towards a direction of compression and then an opposition direction of recovery;

FIG. 16 is a partially sectional view of the mouse structure of FIG. 11, in which the first roller tilts towards the right side of the figure relative to the casing;

FIG. 17 is a partially sectional view of the mouse structure of FIG. 11, in which the first roller tilts towards the left side of the figure relative to the casing;

FIG. 18 is a partially sectional view of a mouse structure according to a further embodiment of the present disclosure, in which the optical sensor perpendicularly faces to the first surface of the second roller;

FIG. 19 is a front view along the sectional line C-C of FIG. 18;

FIG. 20 is a partially sectional view of a mouse structure according to another embodiment of the present disclosure, in which the optical sensor perpendicularly faces to one of the two second surfaces of the second roller; and

FIG. 21 is a front view along the sectional line D-D of FIG. 20.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

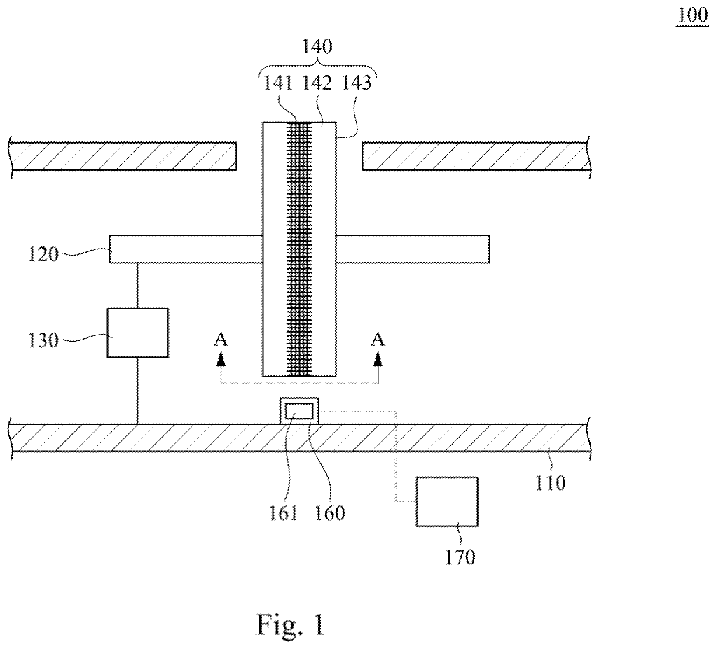

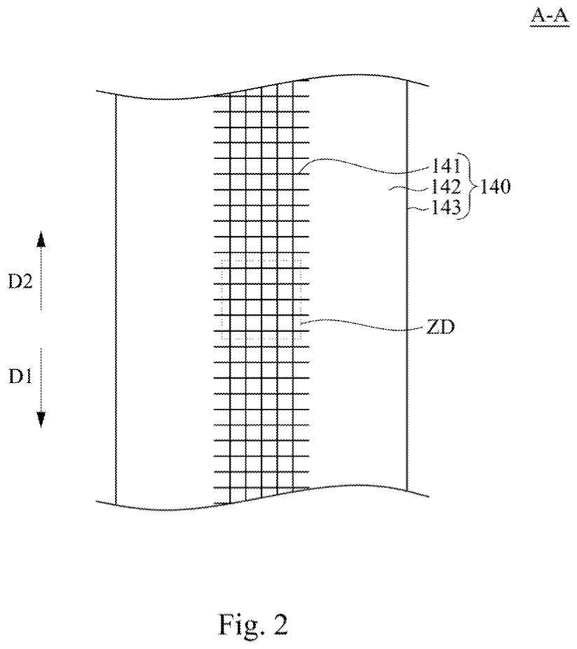

Reference is made to FIGS. 1-2. FIG. 1 is a partially sectional view of a mouse structure 100 according to an embodiment of the present disclosure. FIG. 2 is a front view along the sectional line A-A of FIG. 1. In this embodiment, as shown in FIGS. 1-2, a mouse structure 100 includes a casing 110, a shaft 120, a supporting piece 130, a first roller 140, an optical sensor 160 and an analyzing unit 170. The supporting piece 130 is connected between the casing 110 and the shaft 120. The supporting piece 130 is configured to support the shaft 120 and allow the shaft 120 to move relative to the casing 110. For the sake of drawing simplification, the supporting piece 130 is only shown in a schematic way. Moreover, please be noted that, although the supporting piece 130 is located under the shaft 120 as shown in FIG. 1, this does not intend to limit the present disclosure. The person having ordinary skill in the art can dispose the supporting piece 130 relative to the shaft 120 at an appropriate position on the casing 110 according to the actual situation. The shaft 120 penetrates through and connects with the first roller 140. In other words, the supporting piece 130 also supports the first roller 140 and allows the first roller 140 to move relative to the casing 110, and a moving pattern of the first roller 140 includes rotating, tilting left or tilting right relative to the casing 110, while an elastic movement towards the casing 110 and recovery of the first roller 140 is also included. In addition, the first roller 140 at least partially protrudes outside the casing 110. The first roller 140 has a plurality of superficial features 141. To be specific, at least one of the superficial features 141 can be a mark. For example, the mark can be a line or a scale of different colors. The optical sensor 160 is disposed on the casing 110 and defines a region to be detected ZD (please see FIG. 2 for the region to be detected ZD) on the first roller 140. The superficial features 141 are at least partially located at the region to be detected ZD. The optical sensor 160 is configured to obtain a plurality of images of the region to be detected ZD. The analyzing unit 170 is signally connected with the optical sensor 160 and is configured to determine a moving pattern of the first roller 140 according to the images. To be specific, the analyzing unit 170 can be located inside the casing 110 or disposed in other electronic equipment located outside the casing 110. However, this does not intend to limit the present disclosure.

Furthermore, as shown in FIGS. 1-2, the first roller 140 has a first surface 142 and two second surfaces 143. The two second surfaces 143 are opposite to each other. The first surface 142 is connected between the two second surfaces 143. The shaft 120 penetrates through the two second surfaces 143. The first surface 142 is configured to be operated by a finger of a user, such that the first roller 140 can be rotated, tilted left, tilted right or pressed downwards. In this embodiment, the superficial features 141 are located on the first surface 142 of the first roller 140. The optical sensor 160 perpendicularly faces to the first surface 142 and aligns with the superficial features 141.

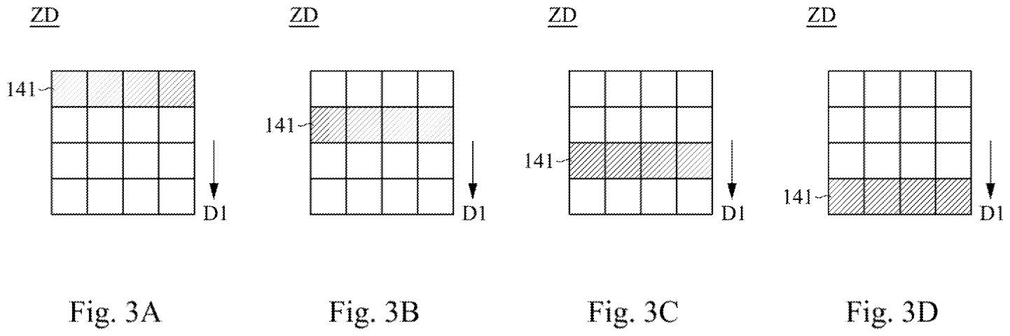

To be specific, when the first roller 140 rotates, the superficial features 141 located on the first surface 142 also rotate, and the optical sensor 160 obtains a plurality of images of the region to be detected ZD. Then, the analyzing unit 170 determines a direction and a speed of the rotation of the first roller 140 through algorithm according to the changes of positions of the superficial features 141 in the images. Reference is made to FIGS. 3A-3D. FIGS. 3A-3D are schematic views showing changes of the images of the region to be detected ZD on the first roller 140 of FIG. 1, in which the superficial features 141 move towards the first direction D1. For the sake of drawing simplification, only one of the superficial features 141 is shown in FIGS. 3A-3D, and FIGS. 3A-3D only show the changes of the images of this one of the superficial features 141 when this one of the superficial features 141 is located within the region to be detected ZD. Please be noted that, when this one of the superficial features 141 has not yet entered into or has left from the region to be detected ZD, none of the superficial features 141 will be present in the region to be detected ZD. As shown in FIGS. 3A-3D, the optical sensor 160 can present the images of the region to be detected ZD in a matrix form. In other words, the optical sensor 160 is further configured to convert the images obtained from the region to be detected ZD into matrix images. When the first roller 140 rotates towards a first direction D1, the images obtained by the optical sensor 160 sequentially record the changes of the positions of at least one of the superficial features 141 in the matrix, which is the moving process of this one of the superficial features 141 towards the first direction D1. Subsequently, the analyzing unit 170 can determine that the user rotates the first roller 140 towards the first direction D1 through algorithm. Furthermore, by the moving distances of at least one of the superficial features 141 in the successive images, the analyzing unit 170 can determine the rotating speed of the first roller 140.

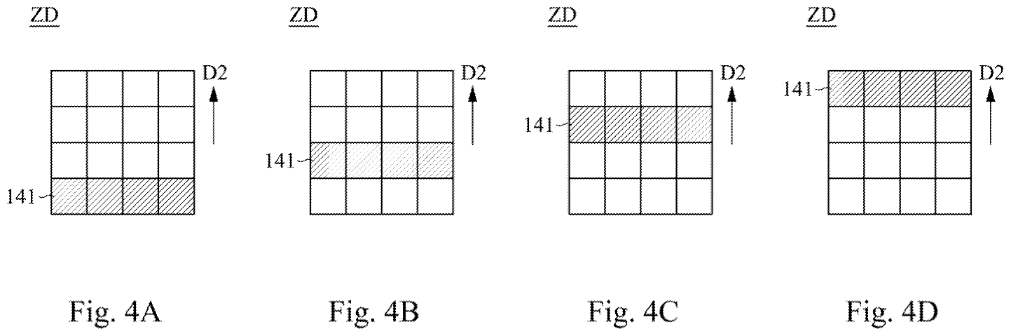

Similarly, reference is made to FIGS. 4A-4D. FIGS. 4A-4D are schematic views showing changes of the images of the region to be detected ZD on the first roller 140 of FIG. 1, in which the superficial features 141 move towards the second direction D2. As shown in FIGS. 4A-4D, when the first roller 140 rotates towards a second direction D2 opposite to the first direction D1, the images obtained by the optical sensor 160 sequentially record the changes of the positions of at least one of the superficial features 141 in the matrix, which is the moving process of this one of the superficial features 141 towards the second direction D2. Subsequently, the analyzing unit 170 can determine that the user rotates the first roller 140 towards the second direction D2 through algorithm.

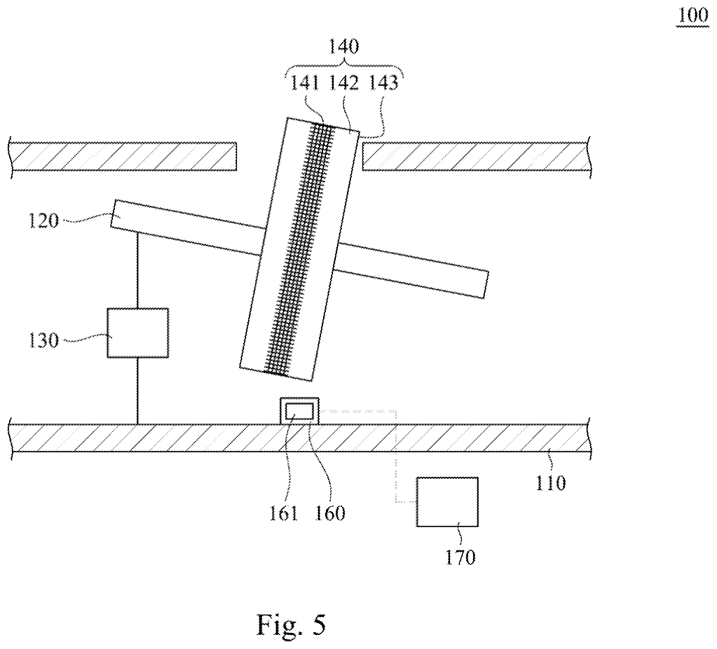

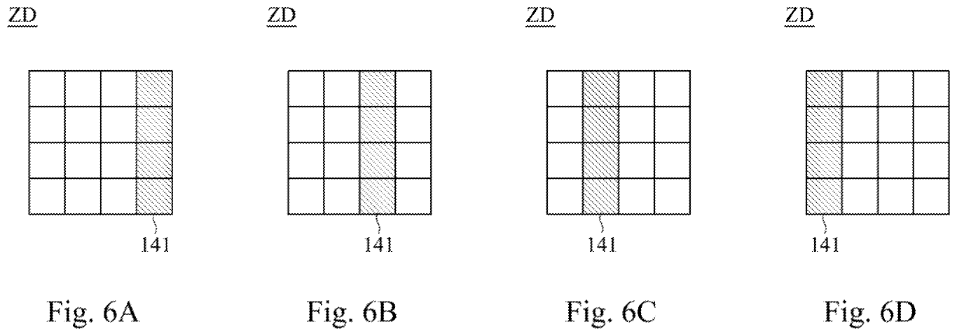

Reference is made to FIG. 5 and FIGS. 6A-6D. FIG. 5 is a partially sectional view of the mouse structure 100 of FIG. 1, in which the first roller 140 tilts towards the right side of the figure relative to the casing 110. FIGS. 6A-6D are schematic views showing changes of the images of the region to be detected ZD on the first roller 140 of FIG. 5, in which the superficial features 141 move towards the left side of the figure. For the sake of easy understanding of the drawings, the first roller 140 is tilted in an exaggerated magnitude, and the optical sensor 160 still aligns with the superficial features 141 located on the first roller 140. In this embodiment, the supporting piece 130 supports the shaft 120 and allows the shaft 120 and the first roller 140 to elastically tilt relative to the casing 110. When the user tilts the first roller 140 towards the right side of the figure relative to the casing 110 as shown in FIG. 5, as shown in FIGS. 6A-6D, the images obtained by the optical sensor 160 sequentially record the changes of the positions of at least one of the superficial features 141 in the matrix, which is the moving process of this one of the superficial features 141 towards the left side of the figure. Subsequently, the analyzing unit 170 can determine that the user elastically tilts the first roller 140 relative to the casing 110 towards the right side of the figure through algorithm.

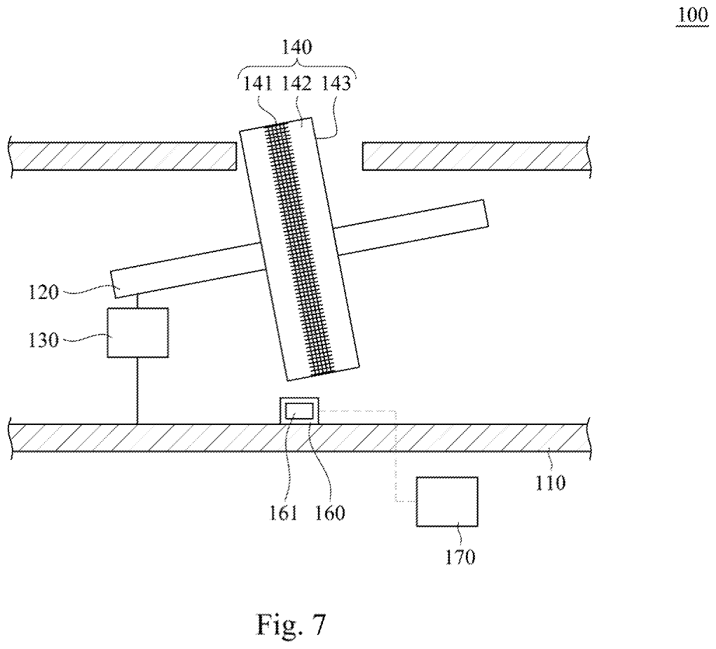

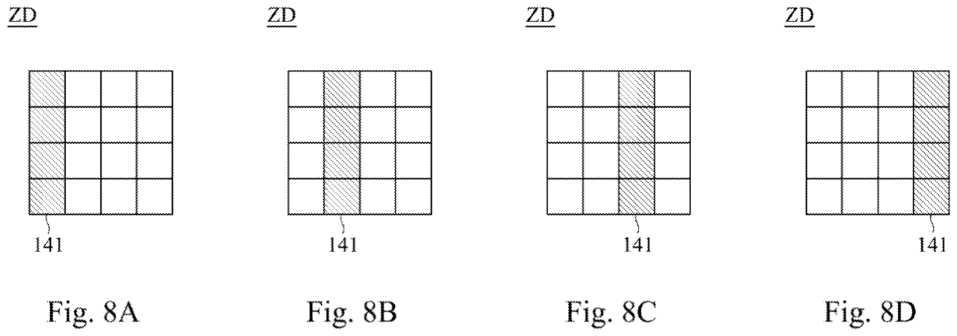

Similarly, reference is made to FIG. 7 and FIGS. 8A-8D. FIG. 7 is a partially sectional view of the mouse structure 100 of FIG. 1, in which the first roller 140 tilts towards the left side of the figure relative to the casing 110. FIGS. 8A-8D are schematic views showing changes of the images of the region to be detected ZD on the first roller 140 of FIG. 7, in which the superficial features 141 move towards the right side of the figure. Similarly, for the sake of easy understanding of the drawings, the first roller 140 is tilted in an exaggerated magnitude, and the optical sensor 160 still aligns with the superficial features 141 located on the first roller 140. In this embodiment, when the user tilts the first roller 140 towards the left side of the figure relative to the casing 110 as shown in FIG. 7, as shown in FIGS. 8A-8D, the images obtained by the optical sensor 160 sequentially record the changes of the positions of at least one of the superficial features 141 in the matrix, which is the moving process of this one of the superficial features 141 towards the right side of the figure. Subsequently, the analyzing unit 170 can determine that the user elastically tilts the first roller 140 relative to the casing 110 towards the left side of the figure through algorithm.

Please go back to FIG. 1. In this embodiment, as shown in FIG. 1, the optical sensor 160 includes a light source 161. The light source 161 is configured to emit a light to the region to be detected ZD. Moreover, in this embodiment, the supporting piece 130 supports the shaft 120 and allows the shaft 120 and the first roller 140 to elastically move towards the optical sensor 160. When the user presses on the first roller 140, the first roller 140 moves towards the optical sensor 160, and then the first roller 140 elastically recovers and moves away from the optical sensor 160. In this process, since the distance between the first surface 142 of the first roller 140 and the optical sensor 160 reduces first and then recovers, a brightness of the region to be detected ZD as irradiated by the light emitted from the light source 161 also changes correspondingly. Thus, the optical sensor 160 obtains the successive images with brightness which increases first and then recovers. Subsequently, the analyzing unit 170 can determine that the user presses the first roller 140 downwards relative to the casing 110 through algorithm.

In simple words, since the analyzing unit 170 can determine through algorithm whether the first roller 140 is rotated, tilted left, tilted right or pressed downwards, and also determine a rotating speed of the first roller 140, according to the images of the region to be detected ZD on the first roller 140 obtained by the optical sensor 160, the internal structure of the mouse structure 100 can be effectively simplified. Moreover, the design of electric circuit involved can also be simplified.

Moreover, since the mouse structure 100 can omit switches and encoders used in traditional mice, manufacturing materials and cost of manufacture can be further reduced.

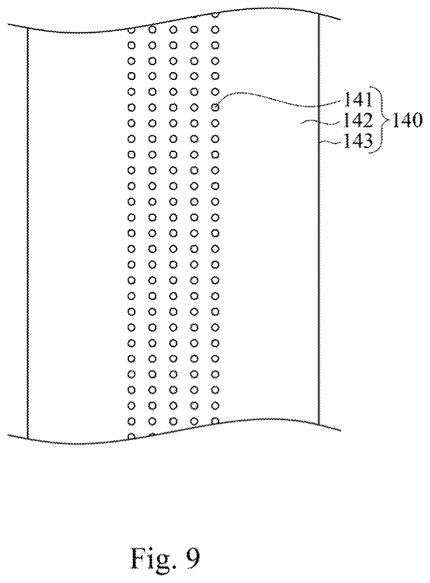

Reference is made to FIG. 9. FIG. 9 is a regionally enlarged view of the first roller 140 of FIG. 1, in which the superficial features 141 are in blocky shapes. In this embodiment, each of the superficial features 141 can be a mark of a blocky shape. As shown in FIG. 9, each of the superficial features 141 can be of a circular block. According to the actual situation, in other embodiments, each of the superficial features 141 can be of a block of triangular, rectangular, polygonal or other shape.

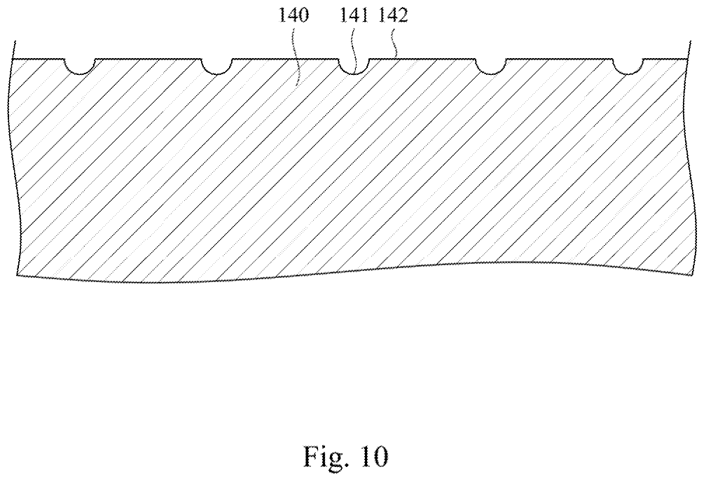

Reference is made to FIG. 10. FIG. 10 is a regionally enlarged view of the first roller 140 of FIG. 1, in which the superficial features 141 are grooves. In this embodiment, as shown in FIG. 10, each of the superficial features 141 can be a groove disposed on the first surface 142, and a depth of each of the grooves can be adjusted according to the actual situation.

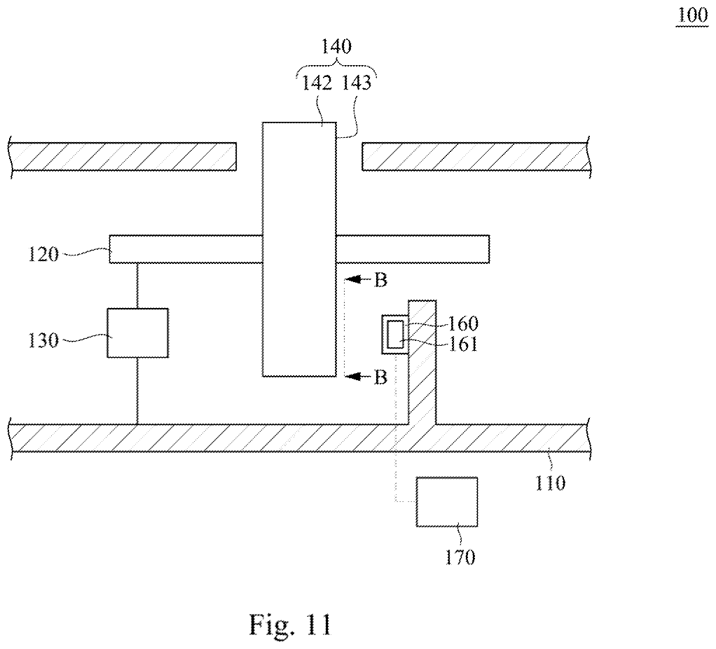

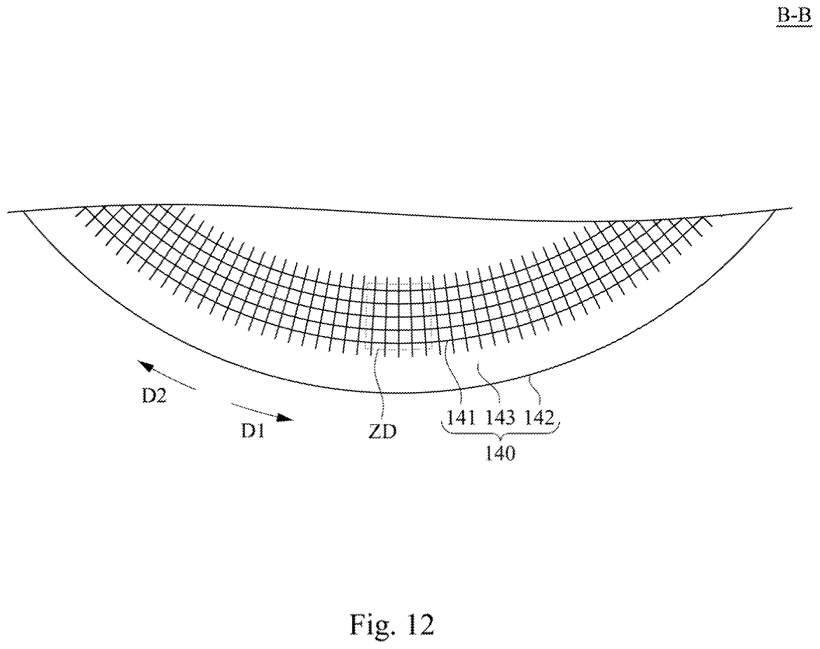

Reference is made to FIGS. 11-12. FIG. 11 is a partially sectional view of a mouse structure 100 according to another embodiment of the present disclosure, in which the optical sensor 160 perpendicularly faces to one of the two second surfaces 143. FIG. 12 is a front view along the sectional line B-B of FIG. 11. In this embodiment, as shown in FIGS. 11-12, the superficial features 141 are located on one of the two second surfaces 143 of the first roller 140. The optical sensor 160 perpendicularly faces to a corresponding one of the two second surfaces 143 disposed with the superficial features 141 thereon.

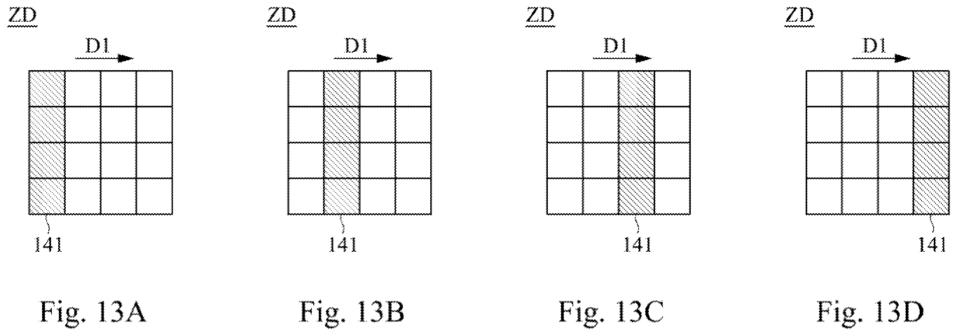

Reference is made to FIGS. 13A-13D. FIGS. 13A-13D are schematic views showing changes of the images of the region to be detected ZD on the first roller 140 of FIG. 12, in which the superficial features 141 move towards the first direction D1. As shown in FIGS. 13A-13D, when the first roller 140 rotates towards the first direction D1, the images obtained by the optical sensor 160 sequentially record the moving process of at least one of the superficial features 141 towards the first direction D1. Subsequently, the analyzing unit 170 can determine that the user rotates the first roller 140 towards the first direction D1 through algorithm. Furthermore, by the moving distances of at least one of the superficial features 141 in the successive images, the analyzing unit 170 can determine the rotating speed of the first roller 140.

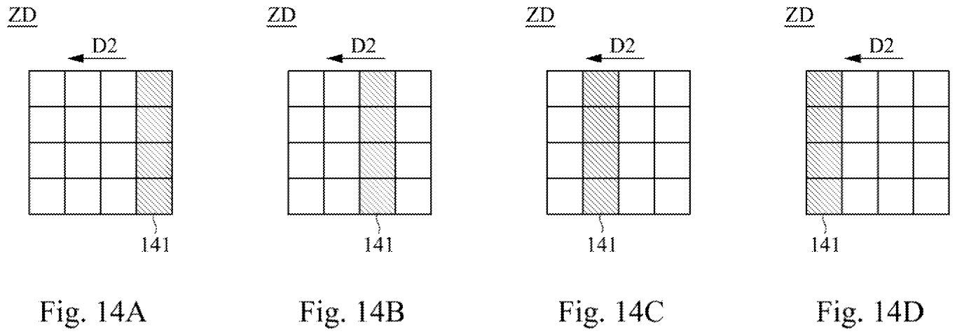

Reference is made to FIGS. 14A-14D. FIGS. 14A-14D are schematic views showing changes of the images of the region to be detected ZD on the first roller 140 of FIG. 12, in which the superficial features 141 move towards the second direction D2. As shown in FIGS. 14A-14D, when the first roller 140 rotates towards the second direction D2 opposite to the first direction D1, the images obtained by the optical sensor 160 sequentially record the moving process of at least one of the superficial features 141 towards the second direction D2. Subsequently, the analyzing unit 170 can determine that the user rotates the first roller 140 towards the second direction D2 through algorithm.

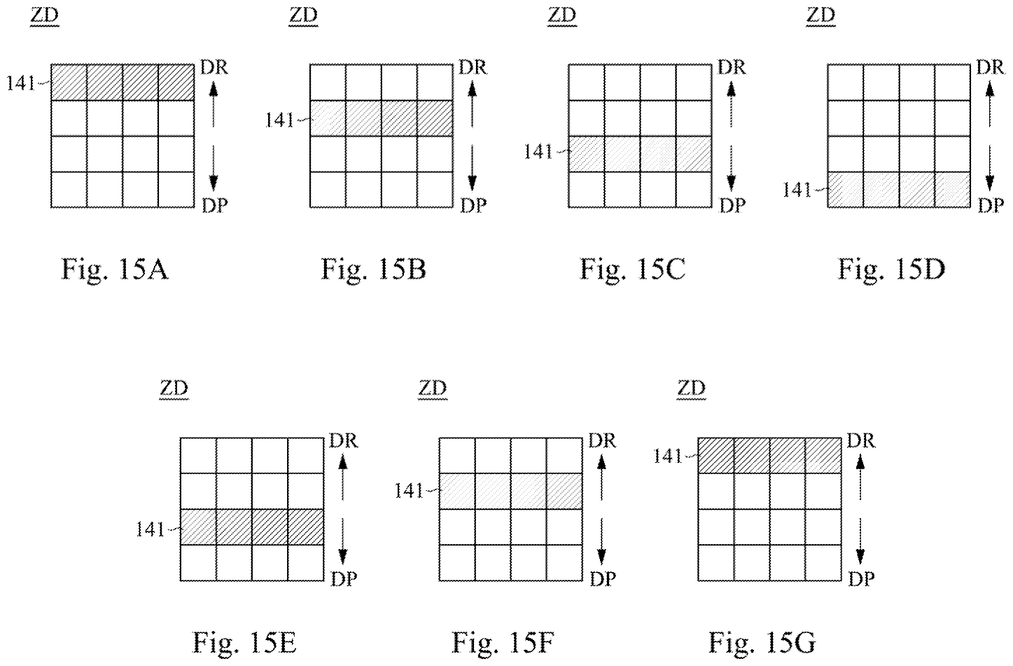

Reference is made to FIGS. 15A-15G. FIGS. 15A-15G are schematic views showing changes of the images of the region to be detected ZD on the first roller 140 of FIG. 12, in which the superficial features 141 move towards a direction of compression DP and then an opposition direction of recovery DR. To be specific, when the user presses the first roller 140 along a direction of compression DP, the first roller 140 moves along the direction of compression DP first, and then the first roller 140 elastically recovers and moves along a direction of recovery DR which is opposite to the direction of compression DP. Thus, as shown in FIGS. 15A-15G, the images obtained by the optical sensor 160 sequentially record the process of at least one of the superficial features 141 moving downwards and then upwards. Subsequently, the analyzing unit 170 can determine that the user presses the first roller 140 downwards relative to the casing 110 through algorithm.

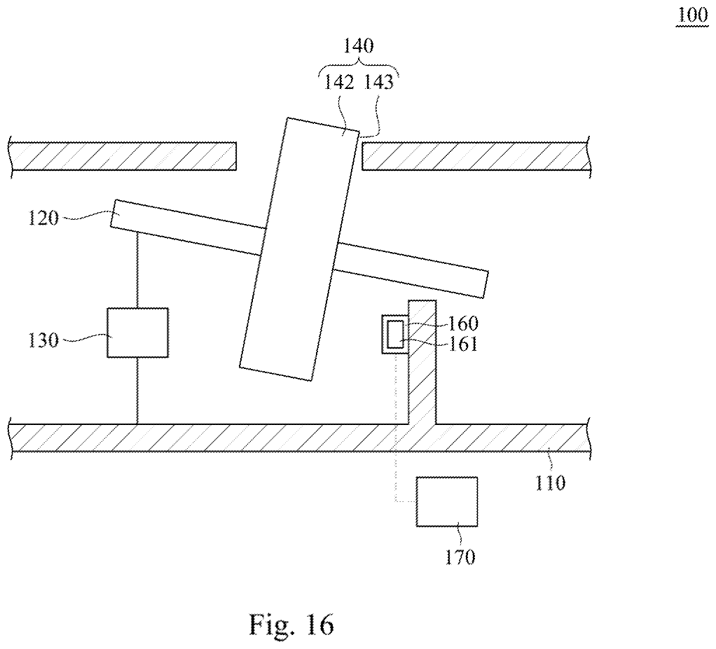

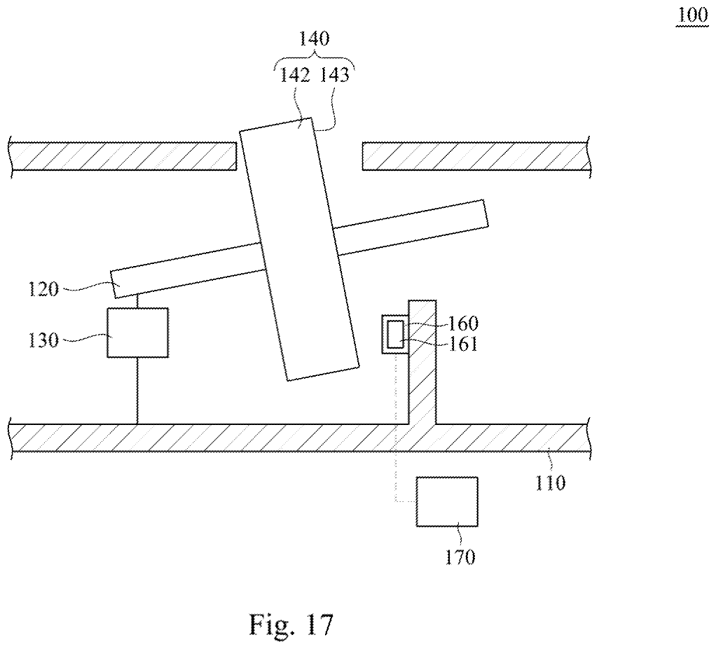

Reference is made to FIGS. 16-17. FIGS. 16 and 17 are partially sectional views of the mouse structure 100 of FIG. 11, in which the first roller 140 respectively tilts towards the right side and the left side of the figure relative to the casing 110. In this embodiment, the optical sensor 160 includes a light source 161. The light source 161 is configured to emit a light to the region to be detected ZD (please see FIG. 12 for the region to be detected ZD). When the user tilts the first roller 140 towards the right side or the left side of the figure relative to the casing 110 as shown in FIGS. 16-17, since the distance between the proximal one of the two second surfaces 143 of the first roller 140 and the optical sensor 160 either increases or reduces, a brightness of the region to be detected ZD as irradiated by the light emitted from the light source 161 also changes correspondingly. Thus, the optical sensor 160 obtains the successive images with brightness gradually increasing or gradually decreasing. Subsequently, the analyzing unit 170 can determine that the user tilts the first roller 140 towards the right side or the left side of the figure relative to the casing 110 through algorithm.

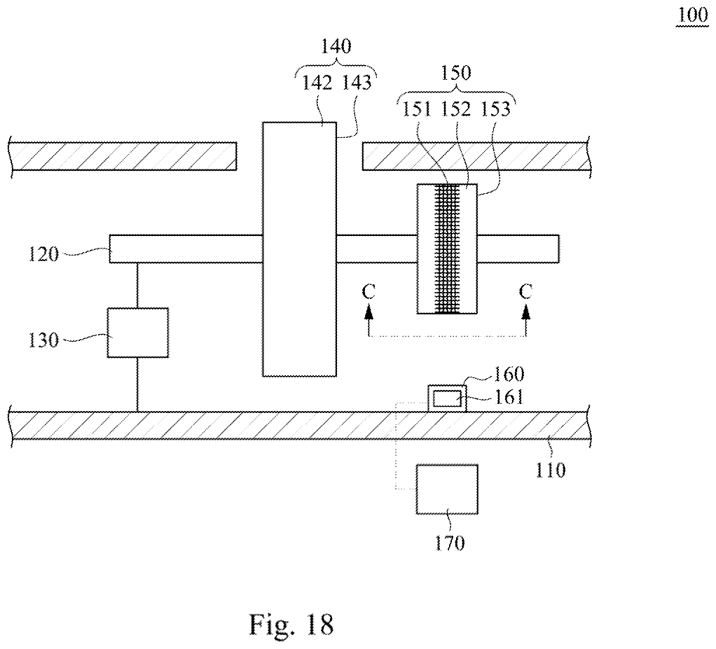

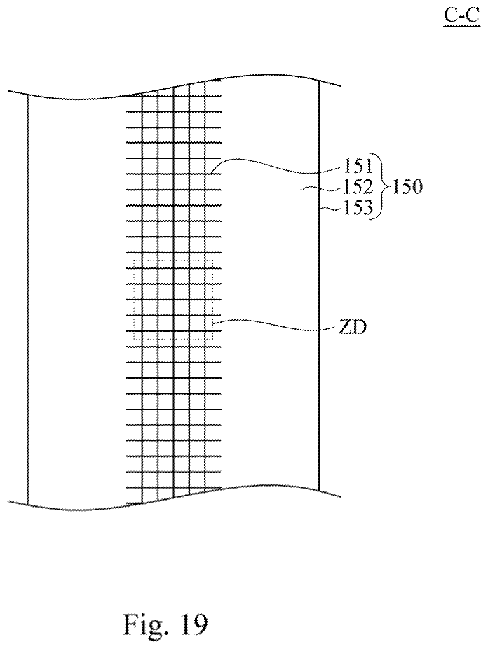

Reference is made to FIGS. 18-19. FIG. 18 is a partially sectional view of a mouse structure 100 according to a further embodiment of the present disclosure, in which the optical sensor 160 perpendicularly faces to the first surface 152 of the second roller 150. FIG. 19 is a front view along the sectional line C-C of FIG. 18. In this embodiment, as shown in FIGS. 18-19, the mouse structure 100 further includes a second roller 150. The shaft 120 penetrates through and connects with the second roller 150. The second roller 150 is located inside the casing 110 and is separated from the first roller 140. The second roller 150 has a plurality of superficial features 151. The optical sensor 160 is disposed on the casing 110 and defines a region to be detected ZD (please see FIG. 19 for the region to be detected ZD) on the second roller 150. The superficial features 151 are at least partially located at the region to be detected ZD. The optical sensor 160 is configured to obtain a plurality of images of the region to be detected ZD. The analyzing unit 170 is signally connected with the optical sensor 160 and is configured to determine a moving pattern of the first roller 140 through algorithm according to the images. In this embodiment, the first roller 140 does not have the superficial features 141 as mentioned above.

Furthermore, as shown in FIGS. 18-19, the second roller 150 has a first surface 152 and two second surfaces 153. The two second surfaces 153 are opposite to each other. The first surface 152 is connected between the two second surfaces 153. The shaft 120 penetrates through the two second surfaces 153. In this embodiment, the superficial features 151 are located on the first surface 152 of the second roller 150. The optical sensor 160 perpendicularly faces to the first surface 152 of the second roller 150 and aligns with the superficial features 151. In this embodiment, the specific working processes of obtaining the images of the region to be detected ZD by the optical sensor 160 and determining a moving pattern of the second roller 150 by the analyzing unit 170 through algorithm, are the same as the aforementioned embodiments in which the superficial features 141 are located on the first surface 142 of the first roller 140, and thus are not described again herein. Moreover, since the shaft 120 penetrates through and connects with both the first roller 140 and the second roller 150 while the second roller 150 and the first roller 140 are separated from each other, the analyzing unit 170 can determine a moving pattern of the first roller 140 through the a moving pattern of the second roller 150.

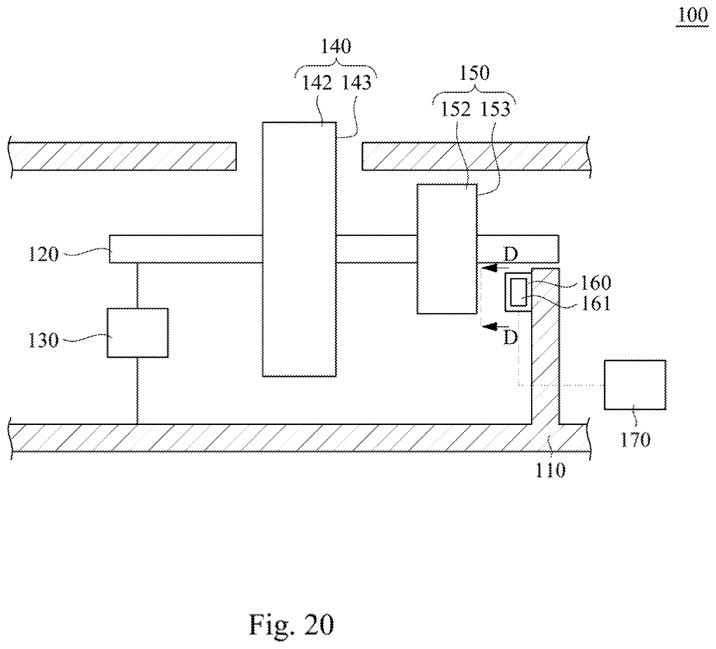

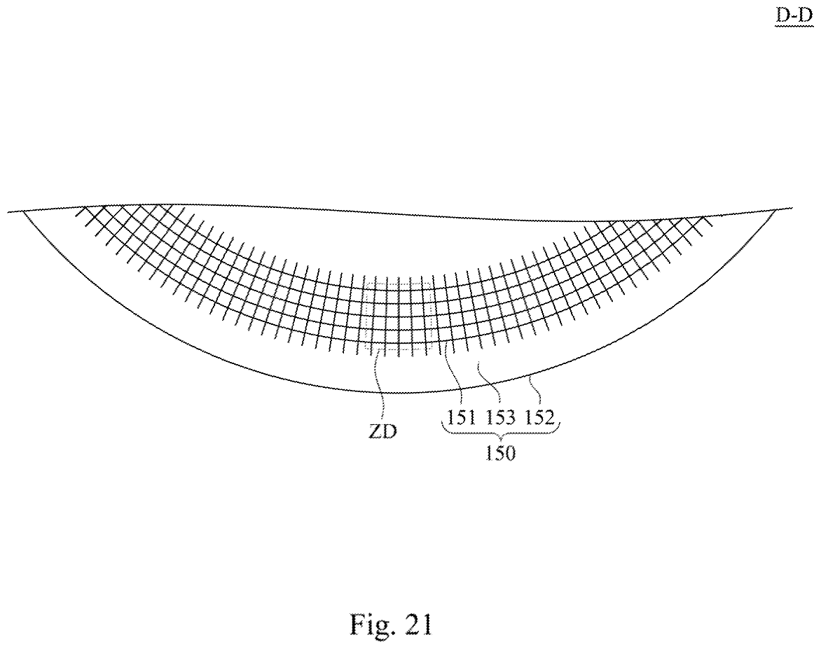

Reference is made to FIGS. 20-21. FIG. 20 is a partially sectional view of a mouse structure 100 according to another embodiment of the present disclosure, in which the optical sensor 160 perpendicularly faces to one of the two second surfaces 153 of the second roller 150. FIG. 21 is a front view along the sectional line D-D of FIG. 20. In this embodiment, as shown in FIGS. 20-21, the superficial features 151 (please see FIG. 21) are located on one of the two second surfaces 153 of the second roller 150. The optical sensor 160 perpendicularly faces to a corresponding one of the two second surfaces 153 disposed with the superficial features 151 thereon. In this embodiment, the specific working processes of obtaining the images of the region to be detected ZD by the optical sensor 160 and determining a moving pattern of the second roller 150 by the analyzing unit 170 through algorithm, are the same as the aforementioned embodiments in which the superficial features 141 are located on one of the two second surfaces 143 of the first roller 140, and thus are not described again herein. Moreover, since the shaft 120 penetrates through and connects with both the first roller 140 and the second roller 150 while the second roller 150 and the first roller 140 are separated from each other, the analyzing unit 170 can determine a moving pattern of the first roller 140 through the a moving pattern of the second roller 150. In this embodiment, the first roller 140 does not have the superficial features 141 as mentioned above.

In conclusion, the aforementioned embodiments of the present disclosure have at least the following advantages:

(1) Since the analyzing unit can determine through algorithm whether the first roller is rotated, tilted left, tilted right or pressed downwards, and also determine a rotating speed of the first roller, according to the images of the region to be detected on the first roller or the second roller obtained by the optical sensor, the internal structure of the mouse structure can be effectively simplified. Moreover, the design of electric circuit involved can also be simplified.

(2) Since the mouse structure can omit switches and encoders used in traditional mice, manufacturing materials and cost of manufacture can be further reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

1. A mouse structure, comprising:
a casing;
a shaft;
a supporting piece connected between the casing and the shaft, the supporting piece being configured to support the shaft and allow the shaft to move relative to the casing;
a roller, the shaft penetrating through and connecting with the roller, the roller at least partially protruding outside the casing and having a plurality of superficial features;
an optical sensor disposed on the casing and defining a region to be detected on the roller, the superficial features being at least partially located at the region to be detected, the optical sensor being configured to obtain a plurality of images of the region to be detected; and
an analyzing unit signally connected with the optical sensor and configured to determine a moving pattern of the roller according to the images.

2. The mouse structure of claim 1, wherein the roller has a first surface and two second surfaces, the two second surfaces are opposite to each other, the first surface is connected between the two second surfaces, the shaft penetrates through the two second surfaces, the superficial features are located on the first surface, the optical sensor perpendicularly faces to the first surface.

3. The mouse structure of claim 2, wherein the optical sensor comprises a light source, the light source is configured to emit a light to the region to be detected.

4. The mouse structure of claim 1, wherein the roller has a first surface and two second surfaces, the two second surfaces are opposite to each other, the first surface is connected between the two second surfaces, the shaft penetrates through the two second surfaces, the superficial features are located on one of the two second surfaces, the optical sensor perpendicularly faces to a corresponding one of the two second surfaces disposed with the superficial features thereon.

5. The mouse structure of claim 1, wherein at least one of the superficial features is a mark.

6. The mouse structure of claim 1, wherein at least one of the superficial features is a groove.

7. The mouse structure of claim 1, wherein the supporting piece allows the roller to elastically tilt relative to the casing.

8. The mouse structure of claim 1, wherein the supporting piece allows the roller to elastically move towards the optical sensor.

9-16. (canceled)
